(19) United States
(12) Patent Application Publication
(10) Pub. No.: US 2008/0053156 A1
(43) Pub. Date: Mar. 6, 2008

(54) Bushing assembly having cooling support fins

(76) Inventors: William L. Streicher, Granville, OH (US); Terry L. Anderson, Thornville, OH (US)

Correspondence Address: OWENS CORNING, 2790 COLUMBUS ROAD, GRANVILLE, OH, 43023, US

(21) Appl. No.: 11/511,546

(22) Filed: Aug. 29, 2006

(51) Int. Cl. C03B 5/00

(52) U.S. Cl. 65/495

(57) ABSTRACT

An apparatus for producing continuous filaments for streams of molten inorganic material includes a feeder for supplying the molten streams, cooling fins for cooling the molten streams, and cooling support fins for supporting the feeder and for cooling the molten streams. The cooling support fin has an upper open channel that holds a support bar for at least partially supporting the feeder.

### TECHNICAL FIELD AND INDUSTRIAL APPLICABILITY OF THE INVENTION

This invention relates in general to an apparatus for producing continuous fibrous materials, and in particular, to a bushing for producing glass fibers. More particularly, the invention relates to a cooling support fin for a fiber bushing tip plate and a fiber bushing assembly with the same.

### BACKGROUND OF THE INVENTION

In the manufacture of continuous glass fibers, glass forming batch ingredients are added to a melter where they are heated to a molten condition. The molten glass travels from the melter to one or more bushing assemblies by way of a glass delivery system, e.g., a channel and a forehearth. Each bushing has a number of nozzles aligned on a tip plate through which streams of molten glass flow via gravity. Those streams are mechanically drawn to form continuous glass fibers by way of a winder or like device.

It is desirable for all bushing tip nozzles to be positioned in generally the same horizontal plane. Typically, a plurality of cooling fins is provided below the tip plate. The cooling fins extend between rows of the tip plate nozzles. Heat is radiantly and convectively transferred from the nozzles and the glass streams to the fins to ensure proper cooling of the molten glass streams into glass fibers.

### SUMMARY OF THE INVENTION

An apparatus for producing continuous filaments from streams of molten inorganic material includes a feeder, cooling fins and cooling support fins. The feeder has a tip plate having orifices that discharge streams of molten inorganic material. The cooling fins are positioned beneath the tip plate to remove heat from the molten streams. The cooling support fins are positioned beneath the tip plate. The cooling support fins at least partially support the tip plate and remove heat from the molten streams. Each cooling fin has a main body and a support bar where the main body has an upper open channel that holds the support bar in direct contact with the tip plate.

In certain embodiments the main body of the cooling support fin also has a closed lower channel to receive a supply of a cooling fluid. In other embodiments, passageways are positioned beneath the cooling support fins to receive a supply of a cooling fluid.

Also, in certain embodiments, the main body of the cooling support fin is made of a unitary piece of material and the support bar is made of a ceramic material.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a side view, partly in cross section, of a glass feeder having a tip plate, and a cooling manifold that includes one embodiment of a cooling support fin.

FIG. 2 is a view, partially in phantom, taken along the line 2-2 in FIG. 1, showing the position of a cooling support fin in supporting contact with a tip plate of the glass feeder, according to one embodiment.

FIG. 2A is an enlarged view of the cooling support fin shown in FIG. 2.

FIG. 3 is a side view, partly in cross section, of a glass feeder having a tip plate, and a cooling manifold, illustrating another embodiment of a cooling support fin.

FIG. 4 is a view, partially in phantom, taken along the line 4-4 in FIG. 3, showing the position of a cooling support fin in supporting contact with a tip plate of the glass feeder, according to another embodiment.

FIG. 4a is an enlarged view of the cooling support fin shown in FIG. 4.

FIG. 5 is a partial bottom view of a tip plate, a cooling manifold having cooling fins attached thereto, and a cooling support fin.

### DETAILED DESCRIPTION AND PREFERRED EMBODIMENTS OF THE INVENTION

Referring now to the drawings, FIG. 1 illustrates a bushing assembly 10 for holding a body 11 of glass in a molten condition. The bushing assembly 10 is supplied with the molten glass by any suitable device such as a glass melting furnace (not shown). The bushing assembly 10 includes a bushing or glass feeder 12 having a plurality of tips or nozzles 14 which extend from a tip plate 16.

The feeder 12 is heated through electric resistance heating, and operates at a temperature in excess of 2300° F. in many cases. Each nozzle 14 defines an orifice 18 so that a molten stream 13 of glass is discharged from each orifice 18 for attenuation into fibers 15.

In certain embodiments, the tip plate 16 has an easily divisible number of nozzles 14. For example, the tip plate 16 may have 4,000 nozzles 14; consequently, the bushing 12 may produce 4,000 filaments 15. The filaments 15 may be gathered into one or more strands (not shown), which are collected in the form of wound packages. The filaments 15 can be gathered in discrete amounts (e.g., 1,000, 2,000, 3,000 or 4,000) to produce various strands for various uses.

In one aspect, the present development improves production efficiency and increases bushing life because it eliminates sag. Additionally, it allows for a greater number of nozzles 14 in the tip plate 16 due to the ability to make much larger tip plates than formerly practical. Additionally, the use of a lower amount of expensive alloys is possible due to the reduced need for an extensive support configuration for the tip plate. The development uses a unique cooling support arrangement to provide tip plate support, and allow the practical operation of bushings much larger than the current “state-of-the-art” bushing assemblies.

To promote the satisfactory formation of glass filaments 15 of uniform size and characteristics, the industry flows glass through the nozzles 14 at a comparatively low viscosity. On the other hand, it is essential to increase the viscosity of the glass streams 13 adjacent the exterior of the nozzles 14 to satisfactorily attenuate fine filaments 15 from the streams 13. Therefore, as shown in FIG. 5, a cooling manifold 20 is provided for conveying heat away from the glass streams 13 to raise the viscosity of the glass.

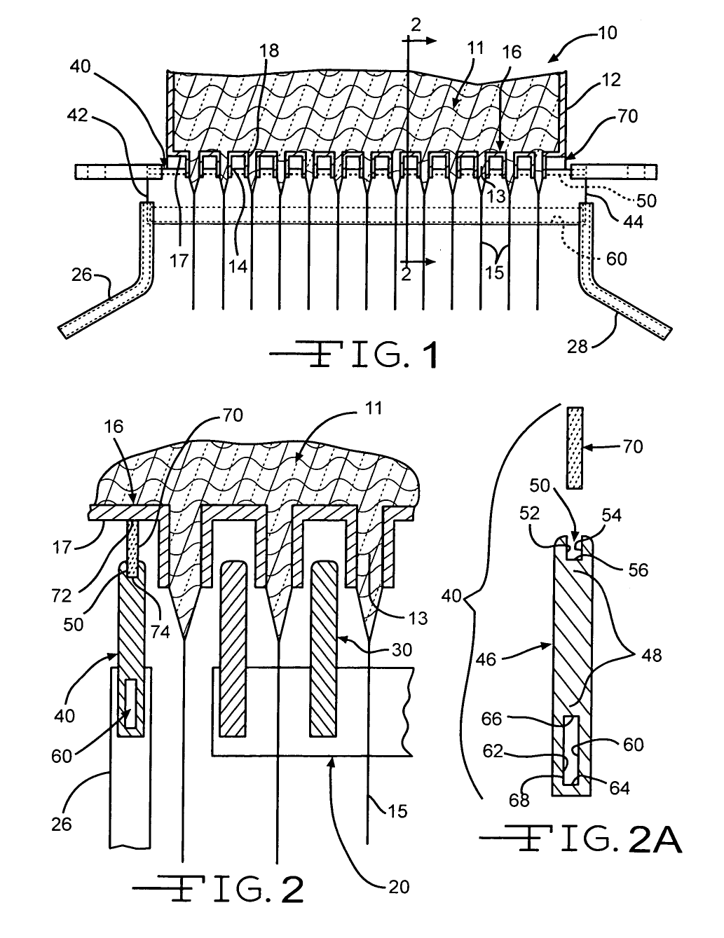

The cooling manifold 20 is positioned beneath the tip plate 16 of the glass feeder 12. The nozzles 14 are in rows and therefore the molten glass streams 13 are in rows. The cooling manifold 20 includes a plurality of heat transfer members 30, generally called cooling fins herein, as shown in FIGS. 2 and 5.

The cooling fins 30 can be positioned so that they are arranged between the rows of nozzles 14 for optimum cooling efficiency. Typically, the cooling fins 30 have one or two rows of nozzles 14 aligned therebetween. Each cooling fin 30 has a first end 32 and a second end 34 which is fused, welded or otherwise secured to the manifold 20, schematically shown in FIG. 5.

The manifold 20 is arranged to accommodate a circulating cooling fluid (not shown). The cooling fins 30 absorb or withdraw heat from the molten glass streams 13 and the heat conducted by the fins 30 to the manifold 20 is carried away by the circulating fluid. In certain preferred embodiments, the cooling fluid comprises water that can be passed through the manifold 20 at a controlled rate of flow and at temperatures predetermined to establish desired temperature differentials between the cooling fins 30 and the molten glass streams 13 being discharged from the nozzles 14. Through this arrangement, the withdrawal or extraction of heat from the molten streams 13 increases the viscosity of the glass to promote efficient attenuation of the streams to fine filaments 15.

In certain embodiments, the cooling fins 30 are solid nickel-plated copper fins; however, in other embodiments, the fins can have a cooling fluid passage (not shown).

When the feeder 12 is relatively new, the tip plate, or tip plate 16 is straight and the cooling fins 30 are uniformly aligned with the nozzles 14. The glass streams 13 emitted from the nozzles 14 are therefore of relatively uniform viscosity, thereby producing glass fibers 15 having uniform properties. However, this uniform coverage occurs only during the early stages of the feeder life. After the feeder 12 has been in operation for a time, the stresses resulting from the high temperatures, the glass weight and the tension caused by attenuation cause the tip plate 16 to begin to sag. The more the tip plate 16 sags, the more uneven the fin coverage or shielding becomes. Thus, heating of the tip plate 14 decreases the structural properties of the tip plate material 14. Stresses resulting from the hydrostatic glass pressure, gravitational force, and forming tension result in high temperature creep of the alloy from which the tip plate 16 is formed. This alloy creep causes deformation of the tip plate 16, causing it to sag downward. As the tip plate 16 sags, the nozzles 14 assume different orientations. Consequently, some of the nozzles 14 are situated closer to certain cooling fins 30 than others.

In the past, in order to compensate for the distorting sag of the tip plate, the filament making process had to be stopped and the cooling fins 30 had to be lowered to the bottom of the lowest nozzles 14. Consequently, the cooling fins 30 were not equidistant from all the nozzles 14. Hence, some of the nozzles 14 were too close to the cooling fins 30, and therefore too cold; and some of the nozzles 14 were too far from the cooling fins 30, and therefore too hot. If the displaced nozzle 14 was too cold, the fiber 15 produced had a decreased diameter. This decreased diameter, along a subsequent increase in forming tension, often caused a breakout of the forming fibers. If the nozzles 14 were too hot, there was an undesired increase in glass flow and a reduction in viscosity, which then lead to flow instability that often caused a breakout. A breakout is an interruption or separation of the fiber 15 formed from the nozzle 14. The breakout requires all the fibers to be broken culminating in a complete fiber forming interruption. The end result is a temporary production loss and generation of scrap fiber.

Another problem is caused by high temperatures. For example, when producing high temperature fiber products, such as the Advantex® glass fiber product produced by Owens Corning, of Toledo, Ohio, U.S.A., the bushing must be heated to greater temperatures than in many other glass forming operations, and this further assaults the integrity of the tip plate 16, further reducing the life expectancy of the bushing 12. The short bushing life causes higher production loss due to replacing the damaged bushing with a costly new bushing. The bushing change procedure requires production stoppage for at least one shift.

Another concern with the short bushing life is that, at the end of the life of the bushing, the bushing is chopped up, refined and used to construct a new bushing. This process is labor intensive and results in some loss of precious resources.

In the present development, cooling fins 40 are used to at least partially support the tip plate 16, thereby prolonging its useful life while simultaneously providing substantially uniform glass filaments 15. Also, the cooling support fins 40 allow for a greater number of nozzles 14 to be used in the tip plate 16.

FIG. 1 shows one cooling support fin 40 positioned to support the tip plate 16 externally from below to prevent deformation of the tip plate 16. It is within the contemplated scope of the present invention that more that one cooling support fin 40 can be used to support the tip plate 16; however, for ease of illustration, only one cooling support fin 40 is shown.

The cooling support fin 40 includes a first end 42 and a second, opposing end 44. As shown in FIG. 1, each cooling support fin 40 is connected to opposing conduits 26 and 28, in heat conducting relation therewith. The conduits 26 and 28 are arranged to accommodate a circulating cooling fluid (not shown).

As best seen in FIGS. 2 and 2a, the cooling support fin 40 includes a main body 46 and a support bar 70. In certain embodiments, the support bar 70 comprises an electrically and thermally insulative material. In certain embodiments, the support bar 70 has a substantially rectangular shape. It has been found that a particularly useful support bar 70 can be comprised of a ceramic material such as an aluminum oxide material that has a desired strength, without being too frangible.

The main body 46 of the cooling support fin 40 includes an open upper channel 50 and a closed lower channel 60. The open upper channel 50 is defined by longitudinally extending and opposing walls 52 and 54 and a bottom surface 56. The walls 52 and 54 and the bottom surface 56 of the open upper channel 50 are configured to hold the support bar 70.

The closed lower channel 60 is situated below the open upper channel 50 such that the open upper channel 50 is separated from the closed lower channel 60 by a middle segment 48 of the main body 46.

The closed lower channel 60 is defined by longitudinally extending walls, shown in FIG. 2a as walls 62, 64, 66 and 68. The closed lower channel 60 can have other suitable shapes. The closed lower channel 60 longitudinally extends between the first and second ends 42 and 44 of the cooling support fin 40. The closed lower channel 60 is configured to receive a substantially continuous flow of a cooling fluid (not shown).

The cooling liquid is supplied through the closed lower channel 60 by way of the corresponding first conduit 26 that is connected to the first end 42 of the cooling support fin 40. The second end 44 of the cooling support fin 40 is in contact with the corresponding second conduit 28 so that the cooling fluid can exit the closed lower channel 60.

In the embodiment shown in FIGS. 1 and 2, the support bar 70 is in contact with a bottom surface 17 of the tip plate 16 and acts as a support for the tip plate 16. As shown in FIG. 2, the support bar 70 has an upper surface 72 that touches and supports the outer bottom surface 17 of the tip plate 16. The support bar 70 also has a lower surface 74 that rests on the bottom surface 56 of the open upper channel 50. In certain other embodiments, a spacer can be positioned between the support bar 70 and the bottom surface 17 of the tip plate 16.

In certain embodiments, the cooling support fin 40 is made of a unitary piece of material, such as a metal, so that the walls 52 and 54 and bottom surface 56 defining the open upper channel 50, the main body 46, and the walls 62, 64, 66 and 68 of the closed lower channel 60 are made as a unitary piece.

Referring again to FIG. 5, one cooling support fin 40 is shown installed on a bushing assembly 10, along with a plurality of cooling fins 30 connected to the manifold 20. While the support bars 40 contact the tip plate 12 and cannot move, the cooling fins 30 can be moved closer to or away from the tip plate 12 to adjust fiber yardage.

The cooling support fin 40 absorbs or withdraws heat from the streams 13 and the heat conducted by the cooling support fin 40 to the conduit 28 is carried away by the circulating fluid. Through this arrangement, the withdrawal or extraction of heat from the streams 13 of glass by the cooling fin 40 also increases the viscosity of the glass to promote efficient attenuation of the streams to fine filaments 15.

In certain embodiments, the open upper channel 50 comprises about 10 to about 50% of the height of the main body 46 cooling support fin 40 such that a middle segment 48 of the main body 46 comprises at least about 50 to about 90% of the height of the cooling support fin 40. Also, in certain embodiments, the lower closed channel 60 has a height that is about 20 to about 50% of the height of the main body 46 of the cooling support fin 40. For example, the open upper channel 50 can have opposing side walls 52 and 54 which are configured to secure a bottom portion, such as, for example, a bottom half of the support bar 70 in the open upper channel 50. Also, other suitable configurations are within the contemplated scope of the present invention.

In certain other useful configurations, the open upper channel 50 comprises about 5 to about 10% of the height of the main body 46, the middle segment 48 comprises at least about 60 to about 70% of the height of the main body 46, and the lower closed channel 60 comprises about 15 to about 25% of the height of the main body 46. For example, the opposing side walls 52 and 54 of the open upper channel 50 can have a height between about 0.06 to about 0.18 inches. The support bar 70 can have a height between about 0.12 to about 0.38 inches so that at least a bottom half of the support bar 70 is secured in the open upper channel 50. The open upper channel 50 can have a cross-sectional width between about 0.06 to about 0.12 inches. The middle segment 48 extending between the open upper channel 50 and the closed lower channel 60 can have a height of about 0.50 to about 1.5 inches. Also, the closed lower channel 60 can have a cross-sectional width between about 0.06 to about 0.12 inches and a height between about 0.12 to about 0.5 inches. Also, other suitable configurations are within the contemplated scope of the present invention.

In certain bushing assemblies, the cooling support fins 40 are evenly spaced beneath and in supporting contact with the outer bottom surface 17 of the tip plate 16. Also, in certain bushing assemblies, cooling support fins 40 can have substantially the same cross-sectional widths as the cooling fins 30. For example, in certain embodiments, the bushing assembly 10 can include 42 cooling fins and three cooling support fins 40. Such embodiment can have, for example, a pattern of eleven cooling fins, a first cooling support fin, ten cooling fins, a second cooling support fin, ten cooling fins, a third cooling support fin, and eleven cooling fins. Other useful configurations are also within the contemplated scope of the present invention.

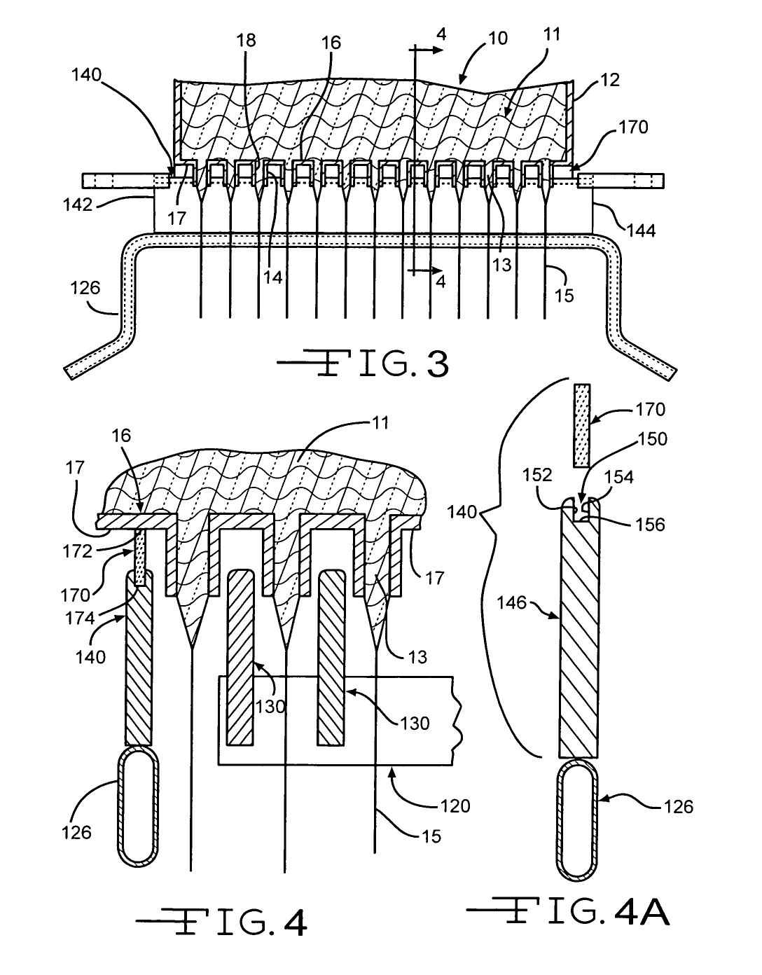

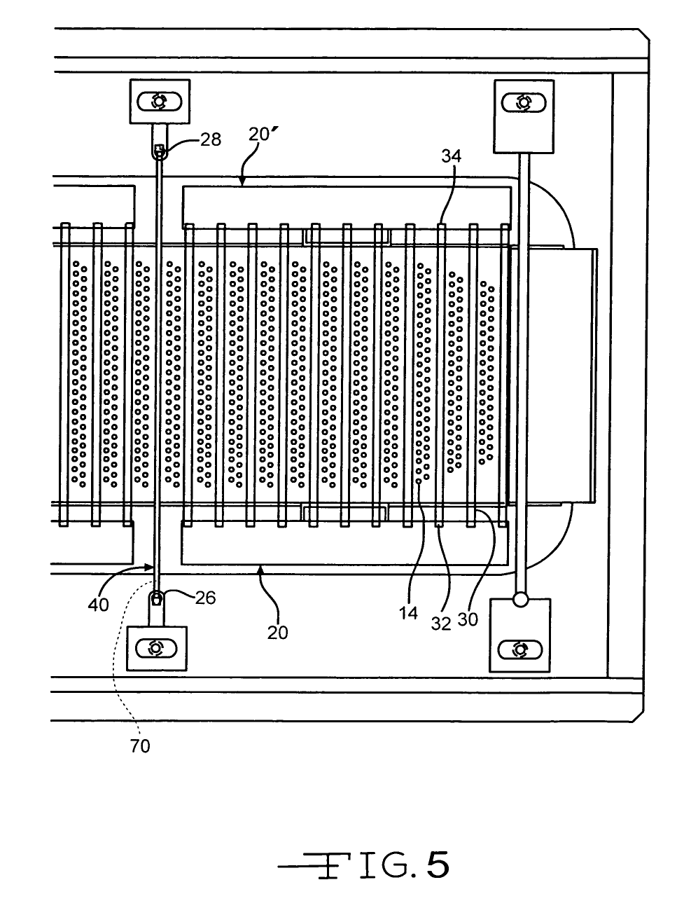

FIGS. 3 and 4 show another embodiment where a cooling support fin 140 has a first end 142 and a second, opposing end 144. For ease of illustration, elements that are the same as those shown in FIGS. 1 and 2 are given the same numerals.

A cooling manifold 120 extends across the tip plate 16 of the glass feeder 12 between the nozzles 14. The cooling manifold 120 includes a plurality of heat transfer members 130, generally called cooling fins herein, as shown in FIG. 4. The cooling fins 130 may divide the nozzles 14 and glass streams 13 in a variety of arrangements. Typically, the cooling fins 130 have one or two rows of nozzles 14 aligned therebetween. Each cooling fin 130 is fused, welded or otherwise secured to a manifold 120 that is arranged to accommodate a circulating cooling fluid (not shown).

As shown in FIG. 3, each cooling support fin 140 is fused, welded or otherwise secured to a longitudinally extending passageway 126, in heat conducting relation therewith.

The passageway 126 is situated below, and in touching contact with, the cooling support fin 140. In some embodiments, the passageway 126 is fused, such as by welding or soldering, to the cooling support fin 140. The passageway 126 extends between the first and second ends 142 and 144 of the cooling support fin 140. The passageway 126 is arranged to accommodate a circulating cooling fluid (not shown).

As best seen in FIGS. 4 and 4a, the cooling support fin 140 includes a main body 146 and a support bar 170. In certain embodiments, the support bar 170 comprises an electrically and thermally insulative material. In certain embodiments, the support bar 170 has a substantially rectangular shape. It has been found that a particularly useful support bar can be comprised of a ceramic material such as an aluminum oxide material that has a desired strength, without being too frangible.

The main body 146 of the cooling support fin 140 includes an open upper channel 150 which is defined by longitudinally extending and opposing walls 152 and 154 and a bottom surface 156. The walls 152 and 154 and the bottom surface 156 of the open upper channel 150 are configured to hold the support bar 170.

The support bar 170 in the cooling support fin 140 is in direct contact with the bottom surface 17 of the tip plate 16 to act as a support for the tip plate 16.

As shown in FIG. 4, the support bar 170 has an upper surface 172 that touches and supports the outer bottom surface 17 of the tip plate 16. The support bar 170 also has a lower surface 174 that rests on the bottom surface 156 of the open upper channel 150.

In certain embodiments, the open channel 150 comprises about 15 to about 25% of the height of the cooling support fin 140. Also, in certain embodiments, the cooling support fin 140, comprised of the main body 146 and the walls 152 and 154, is made of a unitary piece of material, such as a metal. That is, the walls 152 and 154 and the bottom surface 156 defining the open upper channel 150 and the main body 146 are made as a unitary piece.

The cooling support fin 140 absorbs or withdraws heat from the molten streams 13 and the heat conducted by the cooling support fin 140 to the lower passageway 126 is carried away by the circulating fluid. Through this arrangement, the withdrawal or extraction of heat from the molten streams 13 by the cooling support fin 140 also increases the viscosity of the glass to promote efficient attenuation of the streams to fine filaments 15.

In certain embodiments, the open upper channel 150 comprises about 10 to about 50% of the height of the cooling support fin 140 such that the main body 46 comprises at least about 50 to about 90% of the height of the cooling support fin 40. For example, the open upper channel 150 can have opposing side walls 152 and 154 which are configured to secure at least a bottom half of the support bar 170 in the open upper channel 150. Other useful configurations are also within the contemplated scope of the present invention.

In certain other useful configurations, the open upper channel 150 comprises about 5 to about 10% of the height of the cooling support fin 140. For example, in certain useful configurations, the opposing side walls 152 and 154 of the open upper channel 150 can have a height between about 0.06 to about 0.18 inches. The support bar 170 can have a height between about 0.12 to about 0.38 inches so that at least a bottom half of the support bar 170 is secured in the open upper channel 150. The open upper channel 150 can have a cross-sectional width between about 0.06 to about 0.12 inches.

In certain bushing assemblies, the cooling support fins 140 are evenly spaced beneath and in supporting contact with the outer bottom surface 17 of the tip plate 16. Also, in certain bushing assemblies, cooling support fins 140 can have substantially the same cross-sectional widths as the cooling fins 130.

The above descriptions of the preferred and alternative embodiments of the present invention are intended to be illustrative and are not intended to be limiting upon the scope and content of the following claims.

All of the compositions and methods disclosed and claimed herein can be made and executed without undue experimentation in light of the present disclosure. While the compositions and methods of this invention have been described in terms of the foregoing illustrative embodiments, it will be apparent to those skilled in the art that variations, changes, modifications, and alterations may be applied to the compositions and/or methods described herein, without departing from the true concept, spirit, and scope of the invention.

What is claimed is:

1. An apparatus for producing continuous filaments from streams of molten inorganic material comprising:
i) a feeder configured to hold molten inorganic material and having a tip plate, the tip plate having orifices configured to discharge streams of molten inorganic material;
ii) cooling fins positioned beneath the tip plate and spaced apart from the tip plate, the cooling fins being configured to remove heat from the molten streams; and,
iii) cooling support fins positioned beneath the tip plate, the cooling support fins configured to at least partially support the tip plate and to remove heat from the molten streams;
wherein the cooling support fin has a main body and a support bar positioned above the main body to at least partially support the tip plate, the main body having an upper open channel configured to hold the support bar, and the main body further having a closed lower channel configured to receive a supply of a cooling fluid.

2. The apparatus according to claim 1, wherein the support bar is in direct contact with the tip plate.

3. The apparatus according to claim 1, wherein the main body of the cooling support fin is made of a unitary piece of metal.

4. The apparatus according to claim 1, wherein the closed lower channel has a height that is about 20 to about 50% of the height of the main body of the cooling support fin.

5. The apparatus according to claim 1, wherein the support bar comprises a ceramic material.

6. The apparatus according to claim 5, wherein the ceramic material comprises aluminum oxide.

7. The apparatus according to claim 1, wherein the open upper channel in the cooling support fin has opposing side walls configured to secure a portion of the support bar in the open upper channel.

8. The apparatus according to claim 1, wherein the cooling support fins are evenly spaced beneath the tip plate.

9. The apparatus according to claim 1, wherein the cooling support fins have substantially the same cross-sectional widths as the cooling fins.

10. An apparatus for producing continuous filaments from streams of molten inorganic material comprising:
i) a feeder configured to hold molten inorganic material and having a tip plate, the tip plate having orifices configured to discharge streams of molten inorganic material;
ii) cooling fins positioned beneath the tip plate and spaced apart from the tip plate, the cooling fins being configured to remove heat from the molten streams; and,
iii) cooling support fins positioned beneath the tip plate, the cooling support fins configured to at least partially support the tip plate and to remove heat from the molten streams;
wherein the cooling support fin has a main body and a support bar positioned above the main body to at least partially support the tip plate, the main body having an upper open channel configured to hold the support bar, and,
iv) passageways positioned beneath the cooling support fins, the passageways being configured to receive a supply of a cooling fluid.

11. The apparatus according to claim 10, wherein the main body of the cooling support fin is made of a unitary piece of metal.

12. The apparatus according to claim 10, wherein the main body of the cooling support fin comprises at least about 50 to about 90% of the height of the cooling support fin.

13. The apparatus according to claim 10, wherein the support bar comprises a ceramic material.

14. The apparatus according to claim 13, wherein the ceramic material comprises aluminum oxide.

15. The apparatus according to claim 10, wherein the open upper channel in the cooling support fin has opposing side walls configured to secure a portion of the support bar in the open upper channel.

16. The apparatus according to claim 10, wherein the cooling support fins are evenly spaced beneath the tip plate.

17. The apparatus according to claim 10, wherein the cooling support fins have substantially the same cross-sectional width as the cooling fins.

18. A method for producing continuous filaments from streams of molten inorganic material comprising:
supplying streams of molten inorganic material from orifices in a tip plate of a feeder;
removing heat at a controlled rate using cooling fins and cooling support fins; and,
at least partially supporting the tip plate with the cooling support fins;
wherein the cooling support fin has a main body and a support bar positioned above the main body to at least partially support the tip plate, the main body having an upper open channel configured to hold the support bar.

19. The method according to claim 18, wherein passageways positioned beneath the cooling support fins receive a supply of a cooling fluid.

20. The method according to claim 18, wherein the cooling support fins include closed lower channels configured to receive a supply of a cooling fluid.
